(19) United States
(12) Patent Application Publication
(10) Pub. No.: US 2015/0289516 A1
(43) Pub. Date: Oct. 15, 2015

(54) BIOCONTROL OF NEMATODES

(71) Applicant: BAYER CROPSCIENCE LP, Research Triangle Park, NC (US)

(72) Inventors: Jonathan S. Margolis, West Sacramento, CA (US); Reed Nathan Royalty, West Sacramento, CA (US); Varghese Thomas, West Sacramento, CA (US)

(21) Appl. No.: 14/437,774

(22) PCT Filed: Oct. 28, 2013
(86) PCT No.: PCT/US2013/067128

§ 371 Date: Apr. 22, 2015

Related U.S. Application Data
(60) Provisional application No. 61/719,349, filed on Oct. 26, 2012.

(51) Int. Cl. A01N 63/02; A01N 63/00

(52) U.S. Cl. CPC A01N 63/02; A01N 63/00

(57) ABSTRACT

The present invention provides a method for using a Bacillus strain as a nematicide and related compositions.

### FIELD OF INVENTION

The present invention relates to control of plant parasitic nematodes.

### BACKGROUND OF INVENTION

Plant parasitic nematodes cause significant damage to a wide variety of crops, resulting in global crop yield losses estimated to range from 5% to 12% annually. Root damage by nematodes is very common and leads to stunted plants, which have smaller root systems, show symptoms of mineral deficiencies in their leaves and wilt easily. Damage by nematodes also predisposes plants to infection by a wide variety of plant pathogenic fungi and bacteria.

In order to combat and control nematodes, farmers typically use chemical nematicides. These range from gas and liquid fumigation, such as methyl bromide and chloropicrin, to application of organophosphates and carbamates, such as thionazin and oxamyl. Use of these chemical nematicides has been ongoing for several decades. Despite the effectiveness of the chemical nematicide in controlling target nematodes, there are serious limitations to these methods. One limitation is that chemical nematicides cannot act against nematodes that have already penetrated the root. Another limitation is the danger associated with the production and use of chemical nematicides. Chemical nematicides are highly toxic and can lead to human poisoning and death. As a result, countries have restricted and sometimes banned certain pesticides. Methyl bromide in particular is banned in most countries due to its ozone depleting effects.

Because of these restrictions and bans, there are a lack of viable nematode solutions. The present invention provides a safe and effective means to replace or lessen the use of chemical pesticides.

### SUMMARY OF THE INVENTION

The present invention provides methods and compositions for the control of plant parasitic nematodes. The invention provides a method for controlling nematodes comprising applying to a plant, a plant part or a locus of the plant an effective amount of Bacillus amyloliquefaciens FZB42, mutants thereof and/or metabolites of this strain or its mutants. In some embodiments, the Bacillus amyloliquefaciens FZB42 is applied as a fermentation product that includes Bacillus amyloliquefaciens FZB42, metabolites and, optionally, residual fermentation broth.

In some embodiments, the target nematodes are disease causing root knot nematodes. In certain instances, the nematodes are from the species Meloidogyne. In other embodiments, the target nematodes are cyst nematodes. In certain instances, the nematodes are from the species Heterodera. In other instances, the nematodes are from the species Globodera.

In some embodiments, the above-described compositions are mixed with at least one other pesticide, such as a fungicide, insecticide, nematicide or herbicide in a synergistically effective amount. In one embodiment, the pesticide is a nematicide. In certain embodiments the Bacillus amyloliquefaciens FZB42-based nematicide is tank mixed with a commercially available formulated nematicide. In other embodiments, the Bacillus amyloliquefaciens FZB42-based composition is mixed with the active ingredient and then formulated, such that the multiple actives form one product.

Compositions of the present invention comprise Bacillus amyloliquefaciens FZB42, nematicidal mutants thereof and/or nematicidal metabolites of this strain or its mutants and at least one other nematicide in a synergistically effective amount. In some embodiments, the at least one other nematicide is selected from the group consisting of Bacillus subtilis QST713 and nematicidal mutants thereof, Bacillus pumilus QST2808 and nematicidal mutants thereof, fluopyram, Bacillus firmus CNMC I-1582 and nematicidal mutants thereof, and Paecilomyces lilacinus-based products, such as the commercial product BIOACT®.

The present invention further provides any of the compositions of the present invention further comprising a formulation inert or other formulation ingredient, such as polysaccharides (starches, maltodextrins, methylcelluloses), proteins (whey protein, peptides), gums, sugars (lactose, trehalose, sucrose), lipids (lecithin, vegetable oils, mineral oils), salts (sodium chloride, calcium carbonate, sodium citrate), and silicates (clays, amorphous silica, fumed/precipitated silicas, silicate salts). In some embodiments, such as those in which the compositions are applied to soil, the compositions of the present invention comprise a carrier, such as water or a mineral or organic material such as peat that facilitates incorporation of the compositions into the soil. In some embodiments, such as those in which the composition is used for seed treatment or as a root dip, the carrier is a binder or sticker that facilitates adherence of the composition to the seed or root. In another embodiment in which the compositions are used as a seed treatment the formulation ingredient is a colorant. In other compositions, the formulation ingredient is a preservative.

In some embodiments the compositions are applied to plants, plant parts, or loci of the plants, such as soil, prior to planting. In other embodiments the compositions are applied at planting. In still others the compositions are applied after planting.

In certain embodiments, application of the compositions is preceded by a step comprising identifying that the plant or plant locus for growth needs treatment. In some embodiments, identifying includes determining that the locus for plant growth exceeds the economic threshold for nematode infestation.

In some embodiments, the present invention encompasses a kit that includes Bacillus amyloliquefaciens FZB42 and instructions for its use as a nematicide. In some embodiments these instructions are a product label. In some embodiments, these instructions are for use of Bacillus amyloliquefaciens FZB42 as a nematicide in combination with a chemical nematicide. In certain instances, the instructions direct the user to use the chemical nematicide at a rate that is lower than the rate recommended on a product label for the chemical nematicide when used as a stand-alone treatment.

### DETAILED DESCRIPTION OF THE INVENTION

All publications, patents and patent applications, including any drawings and appendices, herein are incorporated by reference to the same extent as if each individual publication or patent application was specifically and individually indicated to be incorporated by reference.

The following description includes information that may be useful in understanding the present invention. It is not an admission that any of the information provided herein is prior art or relevant to the presently claimed inventions, or that any publication specifically or implicitly referenced is prior art.

Bacillus amyloliquefaciens FZB42 is available from ABiTEP GMBH, Germany, as the plant strengthening product RHIZOVITAL®. FZB42 is described in European Patent Publication No. EP2179652 and also in Chen, et al., “Comparative Analysis of the Complete Genome Sequence of the Plant Growth-Promoting Bacterium Bacillus amyloliquefaciens FZB42,” Nature Biotechnology Volume 25, Number 9 (September 2007). Mutants of FZB42 are described in International Patent Publication No. WO 2012/130221, including Bacillus amyloliquefaciens ABI01, which was assigned Accession No. DSM 10-1092 by the DSMZ—German Collection of Microorganisms and Cell Cultures.

The microorganisms and particular strains described herein, unless specifically noted otherwise, are all separated from nature and grown under artificial conditions, such as in cultures or through scaled-up manufacturing processes, such as fermentation, described herein. Compositions of the present invention can be obtained by culturing Bacillus amyloliquefaciens FZB42 or its mutants according to methods well known in the art. Conventional large-scale microbial culture processes include submerged fermentation, solid state fermentation, or liquid surface culture. Towards the end of fermentation, as nutrients are depleted, Bacillus cells begin the transition from growth phase to sporulation phase, such that the final product of fermentation is largely spores, metabolites and residual fermentation medium. Sporulation is part of the natural life cycle of Bacillus and is generally initiated by the cell in response to nutrient limitation. Fermentation is configured to obtain high levels of colony forming units of Bacillus and to promote sporulation. The bacterial cells, spores and metabolites in culture media resulting from fermentation may be used directly or concentrated by conventional industrial methods, such as centrifugation, tangential-flow filtration, depth filtration, and evaporation.

The fermentation broth or broth concentrate can be dried with or without the addition of carriers using conventional drying processes or methods such as spray drying, freeze drying, tray drying, fluidized-bed drying, drum drying, or evaporation. Fermentation broth, broth concentrate, and dry products are all referred to herein as “fermentation products.” Compositions of the present invention include fermentation products. In some embodiments, the concentrated fermentation broth is washed, for example via a diafiltration process, to remove residual fermentation broth and metabolites. The resulting dry products may be further processed, such as by milling or granulation, to achieve a specific particle size or physical format. Carriers, described below, may also be added post-drying.

Cell-free preparations of fermentation broth of the novel variants and strains of Bacillus of the present invention can be obtained by any means known in the art, such as extraction, centrifugation and/or filtration of fermentation broth. Those of skill in the art will appreciate that so-called cell-free preparations may not be devoid of cells but rather are largely cell-free or essentially cell-free, depending on the technique used (e.g., speed of centrifugation) to remove the cells. The resulting cell-free preparation may be dried and/or formulated with components that aid in its application to plants or to plant growth media. Concentration methods and drying techniques described above for fermentation broth are also applicable to cell-free preparations.

Metabolites of Bacillus can be obtained according to methods known in the art. The term “metabolites” as used herein may refer to semi-pure and pure or essentially pure metabolites, or to metabolites that have not been separated from the Bacillus strains of the present invention. Concentration methods and drying techniques described above for formulation of fermentation broth are also applicable to metabolites.

Compositions of the present invention may include formulation inerts added to compositions comprising cells, cell-free preparations or metabolites to improve, efficacy, stability, and usability and/or to facilitate processing, packaging and end-use application. Such formulation inerts and ingredients may include carriers, stabilization agents, nutrients, or physical property modifying agents, which may be added individually or in combination. In some embodiments, the carriers may include liquid materials such as water, oil, and other organic or inorganic solvents and solid materials such as minerals, polymers, or polymer complexes derived biologically or by chemical synthesis. In some embodiments, the carrier is a binder or adhesive that facilitates adherence of the composition to a plant part, such as a seed or root. See, for example, Taylor, A. G., et al., “Concepts and Technologies of Selected Seed Treatments”, Annu. Rev. Phytopathol. 28: 321-339 (1990). The stabilization agents may include anti-caking agents, anti-oxidation agents, desiccants, protectants or preservatives. The nutrients may include carbon, nitrogen, and phosphorus sources such as sugars, polysaccharides, oil, proteins, amino acids, fatty acids and phosphates. The physical property modifiers may include bulking agents, wetting agents, thickeners, pH modifiers, rheology modifiers, dispersants, adjuvants, surfactants, antifreeze agents or colorants. In some embodiments, the composition comprising cells, cell-free preparation or metabolites produced by fermentation can be used directly with or without water as the diluent without any other formulation preparation. In some embodiments, the formulation inerts are added after concentrating fermentation broth and during and/or after drying.

The compositions of the present invention may be mixed with other chemical and non-chemical additives, adjuvants and/or treatments, wherein such treatments include but are not limited to chemical and non-chemical fungicides, insecticides, miticides, nematicides, fertilizers, nutrients, minerals, auxins, growth stimulants and the like.

Nematicides with which the Bacillus-based compositions of the present invention may be mixed may be chemical or biological nematicides. The term “chemical nematicide,” as used herein, excludes fumigants, and the term “fumigants” encompasses broad spectrum pesticidal chemicals that are applied to soil pre-planting and that diffuse through the soil (in soil air and/or soil water) and may be applied as gases, such as methyl bromide, volatile liquids, such as chloropicrin, or volatile solids, such as dazomet.

In some embodiments, the chemical or biological nematicide is a commercially available formulated product and is tank mixed with the compositions of the present invention. In other embodiments, the chemical or biological nematicide is mixed with the Bacillus amyloliquefaciens FZB42-based composition prior to formulation such that the compositions form one formulated product. Compositions of the present invention comprise (i) Bacillus amyloliquefaciens FZB42, nematicidal mutants thereof and/or metabolites of this strain or its mutants and (ii) at least one other nematicide in a synergistically effective amount. A “synergistically effective amount” according to the present invention represents a quantity of a combination of (i) Bacillus amyloliquefaciens FZB42 and/or nematicidal mutants thereof and/or nematicidal metabolites of the strain or its mutants and (ii) another nematicide that is statistically significantly more effective against nematodes than (i) or (ii) alone.

Chemical nematicides used in such synergistic mixtures are carbamates, oxime carbamates and organophosphorous nematicides. Carbamate nematicides include benomyl, carbofuran (FURADAN®), carbosulfan and cloethocarb. Oxime carbamates include alanycarb, aldicarb (TEMIK® or as part of the AVICTA® Complete Pak seed treatment from Syngenta), aldoxycarb, (STANDAK®), oxamyl (VYDATE®), thiodicarb (part of the AERIS® seed-applied system from Bayer CropScience), and tirpate. Organophosphorous nematicides include fensulfothion (DANSANIT®), ethoprop, (MOCAP®), diamidafos, fenamiphos, fosthietan, phosphamidon, cadusafos, chlorpyrifos, dichlofenthion, dimethoate, fosthiazate, heterophos, isamidofos, isazofos, phorate, phosphocarb, terbufos, thionazin, triazophos, imicyafos, and mecarphon. Parenthetical names following each compound are representative commercial formulations of each of the above chemicals. Other chemical nematicides useful for such mixtures include spirotetramat (MOVENTO®), MON37400 nematicide, fluopyram and fipronil.

Biological nematicides used in such synergistic mixtures include chitin and urea mixtures, compost extracts and teas (both aerated and nonaerated); compositions comprising the fungus Myrothecium verrucaria and/or metabolites therefrom (commercially available as DITERA®), compositions comprising the fungus Paecilomyces lilacinus (commercially available as, for example, MELOCON® or BIOACT®); compositions comprising the bacterium Pasteuria including P. usgae (commercially available as, for example, ECONEM®); compositions comprising baceteria from the Bacillus sp., including Bacillus firmus (including the strain deposited as CNMC I-1582 with the Collection Nationale de Cultures de Microorganismes, Institute Pasteur, France on May 29, 1995, and commercially available as, for example, VOTIVO®), Bacillus subtilis (including the strain deposited with NRRL as B-21661 on Mar. 7, 1997 and its mutants, also known as Bacillus subtilis QST713), Bacillus amyloliquefaciens, Bacillus pumilus (including the strain deposited with NRRL as B-30087 on Jan. 14, 1999 and its mutants) and Bacillus cereus; and compositions comprising nematicidal Streptomycete sp., such as Streptomyces lydicus (commercially available as ACTINOVATE®). Biological nematicides also include botanically-based nematicides such as products based on neem plants (including seeds or oil from the plants) or azidirachtin, a secondary metabolite of neem seeds, sesame oil-based products (such as DRAGONFIRE®), carvacrol, and products based on plant extracts (such as NEMA-Q®, obtained from the Quillaja saponaria tree of Chile). Biological nematicides also include isolated compounds produced by bacteria, such as the mectins, which are produced by Streptomyces avermentilis, including abamectin (consisting of a combination of abamectin B1a and B1b) and avermectin B2a, and the harpin proteins, originally identified in Erwinia amylovora, including harpin_{EA} and harpin_{αβ}.

Compositions of the present invention are useful to control plant parasitic nematodes, such as, for example, root-knot, cyst, lesion and ring nematodes, including Meloidogyne spp., Heterodera spp., Globodera spp., Pratylenchus spp. and Criconemella sp. Compositions are also useful to control Tylenchulus semipenetrans, Trichodorus spp., Longidorus spp., Rotylenchulus spp., Xiphinema spp., Belonolaimus spp. (such as B. longicaudatus), Criconemoides spp., Tylenchorhynchus spp., Hoplolaimus spp., Rotylenchus spp., Helicotylenchus spp., Radopholus spp. (such as R. citrophilis and R. similis), Ditylenchus spp. and other plant parasitic nematodes. In some embodiments the targets are cyst nematodes, such as Heterodera glycines (soybean cyst nematodes), Heterodera schachtii (beet cyst nematode), Heterodera avenae (Cereal cyst nematode), Meloidigyne incognita (Cotton (or southern) root knot nematode), Globodera rostochiensis and Globodera pallida (potato cyst nematodes). In other embodiments, the targets are root knot nematodes, such as M. incognita (cotton root knot nematode), M. javanica (Javanese root knot nematode), M. hapla (Northern root knot nematode), and M. arenaria (peanut root knot nematode).

The term “control,” as used herein, means killing, reducing in numbers, and/or reducing growth, feeding or normal physiological development, including, for root knot nematodes, the ability to penetrate roots and to develop within roots. An effective amount is an amount able to noticeably reduce pest growth, feeding, root penetration, maturation in the root, and/or general normal physiological development and symptoms resulting from nematode infection. In some embodiments symptoms and/or nematodes are reduced by at least about 5%, at least about 10%, at least about 20%, at least about, 30%, at least about 40%, at least about 50%, at least about 60%, at least about 70%, at least about 80%, or at least about 90%. The term “nematicide,” as used herein, refers to a substance that is able to control nematodes.

Compositions of the present invention are used to treat a wide variety of agricultural and/or horticultural crops, including those grown for seed, produce, and landscaping. Representative plants that can be treated using the compositions of the present invention include but are not limited to the following: bulb vegetables; cereal grains; citrus fruits (such as grapefruit, lemon, and orange); cotton and other fiber crops; curcurbits; fruiting vegetables; leafy vegetables (such as celery, head and leaf lettuce, and spinach); legumes; oil seed crops; peanut; pome fruit (such as apple and pear); stone fruits (such as almond, pecan, and walnut); root vegetables; tuber vegetables; corm vegetables; tobacco, strawberry and other berries; cole crops (such as broccoli and cabbage); grape; pineapple; and flowering plants, bedding plants, and ornamentals (such as fern and hosta). Compositions of the present invention are also used to treat perennial plants, including plantation crops such as banana and coffee and those present in forests, parks or landscaping.

Compositions described herein are applied to a plant, a plant part, such as a seed, root, rhizome, corm, bulb, or tuber, and/or a locus on which the plant or the plant parts grow, such as soil, in order to control plant parasitic nematodes. The compositions of the present invention may be administered as a foliar spray, as a seed/root/tuber/rhizome/bulb/corm treatment and/or as a soil treatment. The seeds/root/tubers/rhizomes/bulbs/corms can be treated before planting, during planting or after planting.

Compositions described herein are also applied to a plant, a plant part, such as a seed, root rhizome, corm, bulb, or tuber, and/or a locus on which the plant or the plant parts grow, such as soil, in order to increase crop yield. In some embodiments, crop yield is increased by at least about 5%, in others by at least about 10%, in still others at least about 15%, and in still others by at least about 20%.

When used as a seed treatment, the compositions of the present invention are applied at a rate of about 1×10² to about 1×10⁹ cfu/seed, depending on the size of the seed. In some embodiments, the application rate is 1×10⁴ to about 1×10⁷ cfu/seed.

When used as a soil treatment, the compositions of the present invention can be applied as a soil surface drench, shanked-in, injected and/or applied in-furrow or by mixture with irrigation water. The rate of application for drench soil treatments, which may be applied at planting, during or after seeding, or after transplanting and at any stage of plant growth, is about 4×10¹¹ to about 8×10¹² cfu per acre. In some embodiments, the rate of application is about 1×10¹⁰ to about 6×10¹² cfu per acre. The rate of application for in-furrow treatments, applied at planting, is about 2.5×10¹⁰ to about 5×10¹¹ cfu per 1000 row feet. In some embodiments, the rate of application is about 6×10¹⁰ to about 4×10¹¹ cfu per 1000 row feet. Those of skill in the art will understand how to adjust rates for broadcast treatments (where applications are at a lower rate but made more often) and other less common soil treatments.

Bacillus-based compositions of the present invention may be applied independently or in combination with one or more other nematicides, such as chemical and biological nematicides, preferably in a synergistically effective amount. In some embodiments, Bacillus amyloliquefaciens FZB42 is co-formulated with at least one other nematicide and the co-formulated product is applied to the plant or plant locus. In some other embodiments, the Bacillus-based compositions are tank mixed with commercially available formulations of the chemical or biological nematicides and applied to plants and plant loci. In other embodiments, the Bacillus-based compositions of the present invention are applied to plants and/or plant loci immediately before or after the commercially available formulations of the chemical or biological nematicides. In other embodiments, the Bacillus-based compositions of the present invention are applied to plants and/or plant loci in rotation with the commercially available formulations of the chemical or biological nematicides. In one aspect, the compositions are applied in rotation in a synergistically effective amount. In one instance, the Bacillus-based compositions are applied as a seed treatment or as an in-furrow or drench treatment, as discussed in more detail below. In some instances of the above embodiments, the commercially available formulations of the chemical or biological nematicides are applied at a rate that is less than the rate recommended on the product label for use of such nematicides as stand-alone treatments.

In other embodiments, the Bacillus-based compositions of the present invention are applied to plants and/or plant loci following application of a fumigant. Fumigants can be applied by shank injection, generally a minimum of 8 inches below the soil surface. Liquid formulations of fumigants can also be applied through surface drip chemigation to move the fumigant to a depth of 8 inches or more below the soil surface. Treated soil beds are covered with a plastic tarp to retain the fumigant in the soil for several days. This is done before planting and allowed to air out prior to planting. The Bacillus-based compositions described herein would be applied after such air-out period either prior to, at the time of, or post-planting. In some instances, the fumigants are applied at a rate that is less than the rate recommended on the product label.

Chemical and biological nematicides are described above. Fumigant nematicides include halogenated hydrocarbons, such as chloropicrin (CHLOR-O-PIC®); methyl bromide (METH-O-GAS®) and combinations thereof (such as BROM-O-GAS® and TERR-O-GAS®); 1,3-dichloropropene (TELONE® II, TELONE® EC, CURFEW ®) and combinations of 1,3-dichloropropene with chloropicrin (TELONE® C-17, TELONE® C-35, and INLINE®); methyl iodide (MIDAS®); methyl isocyanate liberators, such as sodium methyl dithiocarbamate (VAPAM®, SOILPREP®, METAM-SODIUM®); combinations of 1,3 dichloropropoene and methyl isothiocyanate (VORLEX®); and carbon disulfide liberators, such as sodium tetrathiocarbonate (ENZONE®); and dimethyl disulphide or DMDS (PALADINO®). Example commercial formulations of each of the above fumigants are provided in parentheses after the chemical name(s).

Compositions of the present invention may also be applied as part of an integrated pest management (“IPM”) program. Such programs are described in various publications, especially by university cooperative extensions. Such programs include crop rotation with crops that cannot host the target nematode, cultural and tillage practices, and use of transplants. For example, the Bacillus-based compositions could be applied after a season of growth with mustard or other nematode suppressive crop.

In some embodiments, application of the compositions of the present invention to plants, plant parts or plant loci is preceded by identification of a locus in need of treatment. Such identification may occur through visual identification of plants that appear chlorotic, stunted, necrotic, or wilted (i.e., that appear to have nutrient deficiencies) typically coupled with knowledge of a history of nematode problems; plant sampling; and/or soil sampling. Plant sampling may occur during the growing season or immediately after final harvest. Plants are removed from soil and their roots examined to determine the nature and extent of the nematode problem within a field. For root knot nematode, root gall severity is determined by measuring the proportion of the root system which is galled. Galls caused by root knot nematodes may be distinguished from nodules of nitrogen-fixing soil bacteria because galls are not easily separated from the root. Root knot nematode soil population levels increase with root gall severity. In some instances, the detection of any level of root galling suggests a root knot nematode problem for planting any susceptible crop, especially in or near the area of sampling. Cyst nematodes may also be identified by plant sampling and scrutiny of roots for cysts.

Soil sampling offers a means to determine the number of nematodes and/or nematode eggs infesting a certain volume of soil or roots. Soil sampling may be conducted when a problem is first suspected, at final harvest, or any time prior to planting a new crop, including prior to crop destruction of the previous crop. University cooperative extension programs offer soil sampling services, including the University of Florida, Oregon State University and the University of Nebraska-Lincoln. In addition, such programs provide guidance for how to collect samples. For example, in one method of post-harvest predictive sampling, samples are collected at a soil depth of 6 to 10 inches from 10 to 20 field locations over 5 or 10 acres (depending on value of the crop, with fewer acres sampled for higher value crops) in a regular zigzag pattern. In a method of testing established plants, root and soil samples are removed at a soil depth of 6 to 10 inches from suspect plants that are symptomatic but that are not dead or dying, i.e., decomposing.

In some embodiments, identification involves determining whether an economic threshold of nematode infestation has been reached; i.e., a point at which expected economic losses without treatment exceed treatment costs. The economic threshold varies depending on the crop, geography, climate, time of planting, soil type, and/or soil temperature. Numerous papers have been published on this topic and guidelines are available from university cooperative extension programs in different areas. See, for example, Robb, J. G., et al., “Factors Affecting the Economic Threshold for Heterodera schachtii Control in Sugar Beet,” Economics of Nematode Control January-June 1992; Hafez, Saad L., “Management of Sugar Beet Nematode,” University of Idaho Current Information Series (CIS) 1071 (1998); and UC IPM Pest Management Guidelines: Tomato UC ANR Publication 3470 Nematodes A. Ploeg, Nematology, UC Riverside (January 2008). Determining the economic threshold for a particular crop at a particular time of year is well within the skill set of one of ordinary skill in the art.

In some embodiments, the soil sampling reveals that the nematode infestation will cause yield that is about 80%, about 90%, or about 95% of normal for uninfested soil.

In some embodiments, the economic threshold of root knot juveniles per kilogram of soil sample is at least about 250, at least about 300, at least about 500, at least about 750, at least about 1000, at least about 2000, at least about 3000, at least about 4000, at least about 5000, or at least about 6000.

In some embodiments, the economic threshold of cyst nematode eggs and larvae per 1 cm³ soil is at least about 0.5, at least about 1, at least about 2, at least about 3, at least about 4. According to Hafez (1998), supra, a cyst may be estimated as 500 viable eggs and larvae.

We claim:

1. A composition comprising Bacillus amyloliquefaciens FZB42 and/or a nematicidal mutant of Bacillus amyloliquefaciens FZB42, and/or a nematicidal metabolite of Bacillus amyloliquefaciens FZB42 and at least one other nematicide in a synergistically effective amount.

2. The composition of claim 1 wherein the at least one other nematicide is selected from the group consisting of carbamates, oxime carbamates and organophosphorous nematicides.

3. The composition of claim 2 wherein the at least one other nematicide is selected from the group consisting of alanycarb, aldicarb, aldoxycarb, oxamyl, thiodicarb, tirpate, fensulfothion, ethoprop, diamidafos, fenamiphos, fosthietan, phosphamidon, cadusafos, chlorpyrifos, dichlofenthion, dimethoate, fosthiazate, heterophos, isamidofos, isazofos, phorate, phosphocarb, terbufos, thionazin, triazophos, imicyafos, and mecarphon.

4. The composition of claim 1 wherein the at least one other nematicide is selected from the group consisting of spirotetramat, MON37400 nematicide, fluopyram, and fipronil.

5. The composition of claim 1 wherein the at least one other nematicide is Bacillus firmus CNMC I-1582 or a nematicidal mutant of Bacillus firmus CNMC I-1582.
